(19) United States
(12) Patent Application Publication
(10) Pub. No.: US 2003/0083009 A1
(43) Pub. Date: May 1, 2003

(54) Access device internet lock out reature

(76) Inventors: Phillip Kent Freyman, Elgin, IL (US); Komal B. Mehta, Cary, IL (US); Mark Andrew Harris, Elk Grove Village, IL (US)

Correspondence Address: VOLPE AND KOENIG, PC, DEPT MOT, SUITE 400, ONE PENN CENTER, 1617 JOHN F. KENNEDY BOULEVARD, PHILADELPHIA, PA, 19103, US

(21) Appl. No.: 10/002,760

(22) Filed: Oct. 25, 2001

(51) Int. Cl. H04B 1/06

(52) U.S. Cl. 455/26.1; 455/550

(57) ABSTRACT

An access device with an internet lock out feature for “always on” WAN to LAN connections is provided. The access device includes a high speed data port adapted to be connected to an internet and voice service connection. A data port logic transfer layer is connected between the high speed data port and at least one access device local port. A voice service layer is connected to the high speed data port. A user activated switch is provided having a first state in which the data port logic transfer layer is active, and a second state in which the data port logic transfer layer connection to the high speed data port is disabled and the voice service layer remains active.

### BACKGROUND OF THE INVENTION

1. Field of the Invention

The present invention involves an internet lock out feature to prevent internet access in a multi-function line. More specifically, the invention provides a user activated lock out switch for internet access which does not affect voice services or other operations management control (OMC) functionality.

2. Background Information

Due to increased instances of hacker attacks and unauthorized access, users of cable modems or other “always on” types of WAN to LAN modems, such as DSL or ISDN lines, have concerns with limiting such access. To minimize this potential exposure, users of such systems often switch off or un-plug the access devices to prevent remote access. However, service provides are now providing increased services to users of various types of “always on” connections, such as voice over internet protocol (VoIP) services, cable TV signals as well as having control of various overhead management and control functions. When a user switches off or unplugs an access device to prevent remote access, all of the other services are also disabled, preventing primary voice services as well as other services transmitted through such modems, and minimize the operators ability to maintain the system through remote testing or access to perform software downloads during off hours as well as other administrative tasks. Users may also experience long re-registration delays and service disruptions when the access device is reconnected.

One prior known device provided a stand-by switch used in connection with cable modems. The switch disabled the local data ports from the cable port and disabled all of the power indicator LEDs to give the impression that power to the access device had been turned off. However, the network connection for operations management control functions was maintained. While this achieved some of the security goals, it did not provide any pass through functionality, such as voice services. Additionally, no visual indicator was provided for a user to determine the level of connectivity.

Due to the newer capabilities resulting from improvements in digital network speeds, and the transmission of not only data but also voice and multi-media signals, there is an important need for enhanced security.

### SUMMARY

Briefly stated, the present invention provides an access device with an internet lock out feature for “always on” WAN to LAN connections. The access device includes a high speed data port adapted to be connected to an internet and voice service connection. A data port logic transfer layer is connected between the high speed data port and at least one access device local port. A voice service layer is connected to the high speed data port. A user activated switch is provided having a first state in which the data port logic transfer layer is active, and a second state in which the data port logic transfer layer connection to the high speed data port is disabled and the voice service layer remains active.

### BRIEF DESCRIPTION OF THE DRAWINGS

The present invention will hereinafter be described in conjunction with the appended drawing figures, wherein like numerals denote like elements, and:

FIG. 1 is a schematic diagram showing an access device with an internet lock out feature in accordance with the present invention;

FIG. 2 is a front elevational view of a portion of an exemplary internet access device in accordance with the present invention showing the activity indicator LEDs and a manual internet lock out switch;

FIG. 3 is an elevational view of a portion of a computer monitor showing an example of a internet lock out icon indicating the internet lock out switch has been activated.

### DETAILED DESCRIPTION OF THE PREFERRED EMBODIMENT(S)

The ensuing detailed description provides preferred exemplary embodiments only, and is not intended to limit the scope, applicability, or configuration of the invention. Rather, the ensuing detailed description of the preferred exemplary embodiment(s) will provide those skilled in the art with an enabling description for implementing a preferred exemplary embodiment of the invention. It being understood that various changes may be made in the function and arrangement of elements without departing from the spirit and scope of the invention as set forth in the appended claims.

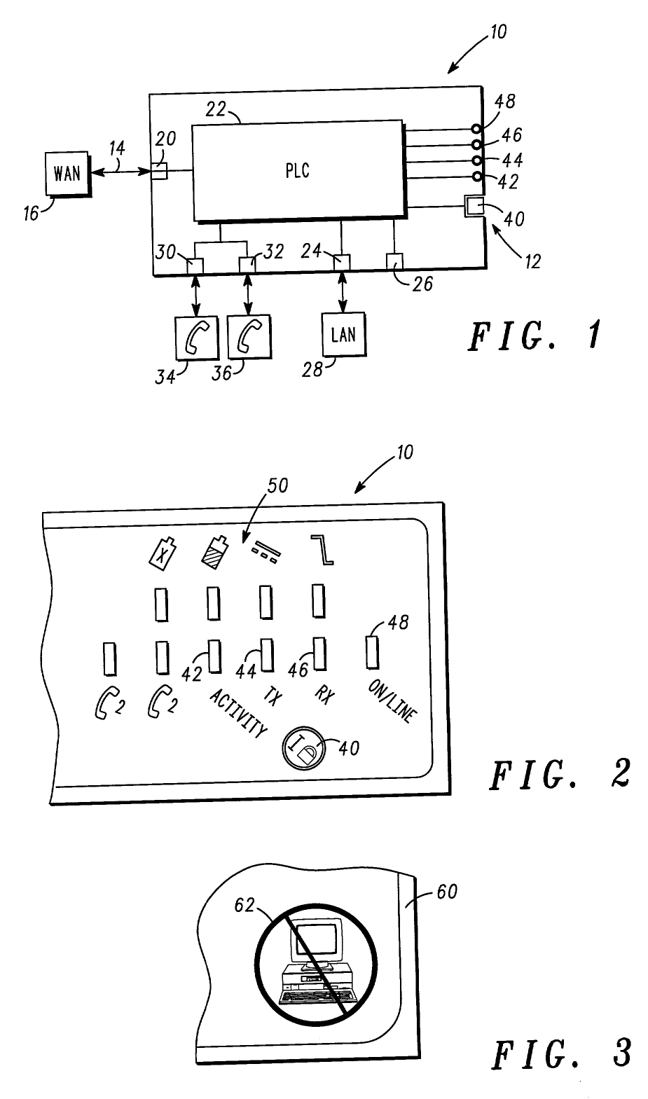

Referring to FIG. 1, a schematic drawing of an access device 10 with an internet lock out feature 12 in accordance with the present invention is shown. The access device 10 is used to connect a wide area network (WAN), such as the internet, to a local area network (LAN), for example through a cable, DSL, ISDN or other type of connection such that voice services are carried over the same access lines 14 from the WAN 16. The access device 10 includes an outside data port 20 which is adapted to be connected to the outside data and voice service connection 14.

Typically, the prior known access devices 10 included an always on feature for outside data connections which could be a security risk for remote access attacks on the LAN.

The programmable logic controller (PLC) 22, which can be formed from hardware, software or a combination thereof, is located inside the access device 10 and includes a data port logic transfer layer connected between the outside data port 20 and at least one access device local data port 24, 26. The local data ports 24, 26 may be connected to a LAN 28, or a PC. The data port logic transfer layer in the PLC 22 routes data received through the outside data port 20 based on the WAN protocol to the LAN IP address or other local device connected to the access device local data port 24, 26. This is done by logical routing based on the local IP address for the data transfer. The PLC 22 also includes a voice server layer connected between the outside data port 20 and at least one access device local voice port 30, 32. This preferably supports VoIP telephony features, such as those required to support primary line services and may be connected to a voice services server 34 or a phone system 36 typically connected to a POTS line or a wireless phone system.

In a first preferred embodiment as shown in FIGS. 1 and 2, the internet lock out feature 12 comprises a manual user activated switch connected to the PLC 22. The switch 40 has a first state in which the data port logic transfer layer connection between the outside data port 20 and the access device local data port is active, and a second state, in which the data port logic transfer layer connection between the outside data port 20 and the access device local data port 24, 26 is disabled, while the voice service layers remains active such that VoIP telephony features remain supported. As shown in FIG. 2, preferably an indicator light 42 is provided to show the state of the switch 40. The switch 40 may be a push button momentary contact switch, a toggle switch or any other type of suitable manually activated switch which is connected to the PLC 22 in order to enable or disable the outside data port connection to the local data ports 24, 26.

When the internet lock out feature 12 is activated, the front panel of the access device 10 preferably indicates the disconnection of the data ports by disabling the appropriate activity indicators, such as the activity indicator 42, the RX indicator 44 and/or the TX indicator 46, either individually or in any combination. Preferably, the on line indicator 48 remains active to indicate that the access device 12 is maintaining network connections for telephony connections and/or diagnostic services or other OMC background operations. Other indicators 50 preferably remain operational.

The internet lock out feature 12 may also be enabled or disabled by a locally connected PC connected to one of the local data ports 24, 26 running an HTTP session using a web browser or other appropriate software. The software may provide a GUI or other appropriate user interface in order to activate the internet lock out feature. Preferably, the PC monitor 60, shown in part in FIG. 3, displays the current state of the access device with an internet lock out feature icon 62 or an unlock icon similar to icon 62 with the overlying circle and slash symbol to indicate that the internet lock feature has not been activated.

In a preferred embodiment, the internet lock out icon or unlock icon is displayed on LAN PCs regardless of whether the lock out feature 12 is an actual physical switch or a software switch activated by the user via a locally connected PC.

In the preferred embodiment, the PLC 22 of the access device 10 is also adapted to remain connected to OMC function services when the internet lock out feature 12 is in the second state, the operations management control function services remain active as well as voice and/or any other non-data transfer functions.

By using the internet lock out feature of the present invention, it is possible to minimize exposure of a LAN or PC to remote access attack through DSL, ISDN or HFC connections to a WAN without disrupting other services, such as VOIP primary voice services, OMC functions and/or other administrative tasks without the need for a fire wall or other software and/or hardware filter to block remote access attacks. This results in a cost savings and a fail safe method for blocking such remote access by creating a logical disconnect of the LAN from the WAN at the logical address layer.

What is claimed is:

1. An access device with an internet lock out feature, comprising:
a outside data port adapted to be connected to an outside data and voice service connection;
a PLC having a data port logic transfer layer connected between the outside data port and at least one access device local data port, and a voice service layer connected between the outside data port and at least one access device local voice port; and
a user activated switch connected to the PLC having a first state, in which the data port logic transfer layer connection between the outside data port and the access device local data port is active, and a second state, in which the data port logic transfer layer connection between the outside data port and the access device local data port is disabled and the voice service layer remains active.

2. The device of claim 1, wherein the outside data port is also adapted to be connected to operations management control function services, and when the switch is in the second state, the operations management control function services remain active.

3. The device of claim 1, wherein the switch is a physical switch having an actuator that changes the switch from the first state to the second state.

4. The device of claim 1, wherein the switch is software implemented in a PC connected to the access device via the access device local port.

5. The device of claim 4, wherein the software displays a current state of the access device on the PC with an internet lock or an internet unlock icon.

6. The device of claim 1, further comprising an indicator panel with at least one online indicator light which indicates when the switch is in the second state.

7. The device of claim 6, further comprising a second indicator light to indicate voice services status.

8. The device of claim 6, wherein the online indicator light blinks when the switch is in the second state and the outside data connection is disabled.
